(19) United States
(12) Patent Application Publication
(10) Pub. No.: US 2025/0153314 A1
(43) Pub. Date: May 15, 2025

(54) FLOATING HAND TOOL WITH INTERCHANGEABLE HEADS

(71) Applicant: AQUA CRAFT TOOLS, LLC, Warren, MI (US)

(72) Inventor: Christopher Urbanek, Warren, MI (US)

(21) Appl. No.: 18/945,975

(22) Filed: Nov. 13, 2024

Related U.S. Application Data
(60) Provisional application No. 63/599,009, filed on Nov. 15, 2023.

(51) Int. Cl. B25B 13/00; B25G 1/10

(52) U.S. Cl. CPC B25B 13/00; B25G 1/105

(57) ABSTRACT

The floating hand tool is provided which includes a floating handle. The floating handle includes a handle portion, and a cap, configured to have highly visible contrasting colors. The cap is selectively coupled to the handle portion to form an airtight chamber. The floating hand tool also includes an elongated member having an anti-rotation means. The handle portion is coupled to the elongated member, the anti-rotation means preventing rotation of the elongated member relative to handle portion. The buoyancy of the airtight chamber of the floating handle in combination with the weight of the elongated member allows the floating hand tool to float in water at a vertical position with the cap fully visible above the water. The contrasting colors in combination with the buoyancy of the floating handle create a buoy effect for high visibility when the floating hand tool is placed or dropped in a body of water.

### CROSS-REFERENCE TO RELATED APPLICATIONS

This application claims the benefit of U.S. Provisional Application No. 63/599,009, filed on Nov. 15, 2023. The entire disclosure of the above application is incorporated herein by reference.

### FIELD

The present technology relates to hand tools, and, more particularly, a floating wrench with interchangeable wrench heads.

### INTRODUCTION

This section provides background information related to the present disclosure which is not necessarily prior art.

Hand tools, such as wrenches and screwdrivers, are used in a wide variety of industries and applications, including mechanical repair, construction, and household tasks. Certain hand tools are constructed with rigid handles that provide durability and grip for applying force. Hand tools such as wrenches, may be open-ended and box-ended to allow for multi-purpose use based on specific dimensions and sizes. Wrenches may also have various shapes and sizes for the purpose of tightening, loosening, and turning objects. A user may employ different varieties of wrenches to match the wrench size to a particular job.

Individuals working in marine environments such as divers, marine technicians, and boat operators, may use hand tools for both routine maintenance and emergency repairs. Tasks may include equipment assembly, hull and engine repair, and general upkeep of underwater or aquatic installations. The nature of these environments, however, presents unique challenges for tool handling, storage, and recovery. Hand tools may be heavy depending on material choice and may include various metals and metal alloys such as chrome-plated or chromium steel alloy, in order to make the wrench sturdy and durable considering expected forces applied thereto. When used near or in bodies of water, such as marine maintenance, pool repair, or boat construction, there is a risk of losing these tools if they are dropped into the water, as they tend to sink due to their weight and material construction. Retrieving a dropped tool may be time-consuming and sometimes impossible, especially when visibility is low, or currents are strong. Loss of tools not only interrupts work but may also pose a hazard to marine ecosystems, as these tools often settle into sediments, rusting or corroding over time. Chrome-plated or chromium steel alloy hand tools may further rust over time due to use, which ultimately may shorten the life cycle of the wrench when used in or near marine environments.

Hand tools suitable for aquatic environments may include various floating or buoyant tools, often with attachments such as foam grips, bulky floatable accessories, or tethering mechanisms. These approaches may enhance a tool's ability to float, however, they are often limited in effectiveness. The added attachments may interfere with the tool's balance, make gripping less ergonomic, or compromise the tool's intended functionality and ease of use. For divers, the added bulkiness of the attachments and accessories often creates a hinderance in movement or visibility of the task itself, making it harder to maneuver such tools in the water.

Hand tools may also be limited in use based on the specific size of the hand tool functionality and/or interchangeability. A user must purchase each individual wrench according to the size of the job and the needs of the user, which may be costly. It may also require a user to own many wrenches which may be a disadvantage for cost and storage reasons.

Hand tools may also be limited with respect to visibility in marine environments, which present very different lighting and backgrounds compared to terrestrial environments. A lack of lighting, dark backgrounds, or reduced visibility due to suspended sediment or particulate in the water may make it very difficult to identify and select a hand tool. This is especially true where the user is partially or fully submerged. Certain hand tools may include a color scheme, using various colors that however are based only on aesthetic appeal, trade dress, or other a color scheme intended to commercial or brand noticeability. These tool colors are not tailored to the particular visibility issues presented by marine environments and may appear dark or obscured in murky or deep water, even if the tools are manufactured to float.

Accordingly, there exists a need for a buoyant, corrosion resistant hand tool with interchangeable and various sized tool heads that provides enhanced visibility in marine environments.

### SUMMARY

In concordance with the instant disclosure, buoyant, corrosion resistant hand tool with interchangeable and various sized tool heads that provides enhanced visibility in marine environments has surprisingly been discovered. The present technology includes articles of manufacture, systems, and processes that relate to a corrosion resistant floating hand tool that may include interchangeable tool heads of different sizes and made to float in water where a portion of the floating handle of the floating hand tool may be visible above the water line.

In certain embodiments, a floating hand tool is provided. The floating hand tool may include a floating handle. The floating handle may include a handle portion having a first end, a second end, and a conical cavity. The first end of the handle portion may include an annular lip disposed around the first end and an annular recess disposed adjacent to the annular lip. The annular lip may also include a bevel. The floating handle may also include a cap having a first end, a second end, and a cylindrical cavity. The first end may include an annular recess and an annular protrusion. The annular protrusion may be configured to be selectively coupled to the first end of the handle portion by engaging the bevel of the annular lip of the handle portion. The floating hand tool may also include an elongated member having a first end, the first end including an anti-rotation means. The anti-rotation means, for example, may include one or more apertures that fill with material of handle portion when molded therewith. In another example, the anti-rotation means may include one or more projections/fins that prevent rotation when handle material is molded therewith. The first end of the handle portion may be coupled to the first end of the cap. The conical cavity of the handle portion and the cylindrical cavity of the cap may be coupled to form an airtight chamber within the floating handle. The second end of the handle portion may then be coupled to the elongated member. Finally, the anti-rotation means of the first end of the elongated member may be embedded in the second end of the handle portion. When fully constructed, the buoyancy of the airtight chamber of the floating handle in combination with the weight of the elongated member may allow the floating hand tool to float in a body of water at a vertical position with the cap fully visible above the water.

In certain embodiments, the cap of the floating handle may be a color visually contrasting from the color of the handle portion of the floating handle. Specifically, the color of the cap may be orange, and the color of the handle portion may be chartreuse. The floating hand tool may have a level of buoyancy where the airtight chamber of the floating handle in combination with the weight of the elongated member allows the floating hand tool to float in water at a vertical position with the cap fully visible above the water and a portion of the handle portion fully visible above the water.

In certain embodiments, a portion of the floating handle may include polypropylene. The floating handle may include a textured surface to improve grip during wet conditions. The floating hand tool may include a temperature-resistant coating on the floating handle to withstand extreme temperatures. The floating hand tool may also include a magnetic element embedded within the floating handle to allow attachment to metal surfaces.

In certain embodiments, a portion of the airtight chamber may be conically shaped. The handle portion of the floating handle may include a sidewall that may be approximately one eighth of an inch thick. The handle portion may have a length of about five inches. In certain embodiments, the handle portion may have a length of about six and a half inches. To create an airtight chamber within the conical cavity of the handle portion and the cylindrical cavity of the cap, the cap may be configured with a waterproof sealant around the recess.

In certain embodiments, the cap may include an illuminating material. The illuminating material may include phosphorescent polypropylene or may be painted with phosphorescent paint or fluorescent paint. The cap may also include an LED light near the first end of the handle portion for enhanced visibility.

In certain embodiments, the elongated member includes a second end. The second end may be made to have interchangeable tool heads. The interchangeable tool heads may include an adjustable crescent wrench, a universal hex wrench, a screwdriver, or a swivel socket.

In certain embodiments, the floating hand tool may include a collection of floating hand tools for use with a diving belt. The collection of floating hand tools may include a plurality of tools, each tool including the floating hand tool including the handle portion, the cap, and the elongated member. Each cap may also have an eyehole. The collection of floating hand tools may also include a plurality of clip hooks, each clip hook made to clip onto each eyehole of each cap respectively and made to attach and detach from a diving belt.

In certain embodiments, a method for constructing a floating hand tool may include the steps of providing the handle portion, a cap, and an elongated member. The method may then include the step of coupling the first end of the handle portion to the first end of the cap. The method may include a step of coupling the conical cavity of the handle portion and the cylindrical cavity of the cap. Next, the method may include the step of forming an airtight chamber within the floating handle. The method may also include the step of coupling the second end of the handle portion to the elongated member. Finally, the method may include the step of embedding the anti-rotation means of the first end of the elongated member in the second end of the handle portion.

In certain embodiments, a method of using a collection of floating hand tools with a diving belt may include the step of providing the collection of floating hand tools that include handle portions, caps, and elongated members. The method may then include providing eyeholes for each cap, and clip hooks for each eyehole. The method may then include the step of coupling the eyeholes to each cap. The method may then include the step of clipping each clip hook onto each eyehole of each cap respectively. The method may include the step of clipping each clip hook onto the diving belt. Next, the method may include the step of submerging the diving belt and floating hand tools into the body of water. The method may include the step of unclipping one of the floating hand tools in the collection for use underwater. Finally, the method may optionally include the step of reclipping the floating hand tool to the diving belt after use.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating a floating hand tool, according to an embodiment of the present disclosure;

FIG. 2 is a perspective view of a floating hand tool with an adjustable crescent wrench, according to an embodiment of the present disclosure;

FIG. 3 is a perspective view of a floating hand tool with a screwdriver and accompanying tool bit set, according to an embodiment of the present disclosure;

FIG. 4 is a perspective view of a floating hand tool with a socket wrench and accompanying socket set, according to an embodiment of the present disclosure;

FIG. 5a is a front perspective view of a floating hand tool with a universal hex, according to an embodiment of the present disclosure;

FIG. 5b is a side perspective view of a floating hand tool with a universal hex wrench, according to an embodiment of the present disclosure;

FIG. 6 is a cross-sectional view showing the coupling of the handle portion, the cap, and the elongated member, according to an embodiment of the present disclosure;

FIG. 7 is a cross-section view of the floating hand tool, according to an embodiment of the present disclosure;

FIG. 8 is a perspective view of the collection of floating hand tools connected with clip hooks to a diver's belt, the floating hand tools coupled to the clip hooks by eyeholes on the caps, according to an embodiment of the present disclosure;

FIG. 9 is a perspective view of a floating hand tool floating in the water in an upright position, with the end cap fully above water, according to an embodiment of the present disclosure;

FIGS. 10a through 10e are perspective views of various handle portions, according to embodiments of the present disclosure;

FIG. 11 shows cross-sectional views of the handle portion according to the embodiment of FIG. 10a;

FIG. 12 shows cross-sectional views of the handle portion according to the embodiment of FIG. 10b;

FIG. 13 shows cross-sectional views of the handle portion according to the embodiment of FIG. 10c;

FIG. 14 shows cross-sectional views of the handle portion according to the embodiment of FIG. 10d;

FIG. 15 shows cross-sectional views of the handle portion according to the embodiment of FIG. 10;

FIGS. 16a and 16b are perspective views of various caps, according to an embodiment of the present disclosure;

FIG. 17 shows cross-sectional views of the cap according to the embodiment of FIG. 16a;

FIG. 18 shows cross-sectional views of the cap according to the embodiment of FIG. 16b;

FIGS. 19a through 19c are perspective views of a swivel socket elongated member, according to an embodiment of the present disclosure;

FIG. 20 shows cross-sectional views of a swivel socket elongated member according to the embodiments of FIGS. 19a through 19c;

FIGS. 21a through 21c are perspective views of various swivel socket interchangeable tool heads, according to an embodiment of the present disclosure;

FIG. 22 shows cross-sectional views of a swivel socket interchangeable tool head according to the embodiment of FIG. 21a;

FIG. 23 shows cross-sectional views of a swivel socket interchangeable tool head according to the embodiment of FIG. 21b;

FIG. 24 shows cross-sectional views of the swivel socket interchangeable tool head of FIG. 21c, according to an embodiment of the present disclosure;

FIG. 25 is a perspective view of an elongated member configured to include a universal hex wrench, according to an embodiment of the present disclosure;

FIG. 26 is a perspective view of an elongated member configured to include a screwdriver, according to an embodiment of the present disclosure;

FIG. 27 shows plan views of an elongated member configured to include a universal hex wrench according to the embodiment of FIG. 25;

FIG. 28 shows plan views of an elongated member configured to include a screwdriver according to the embodiment of FIG. 26;

FIG. 29 shows plan views of an elongated member configured to include an adjustable crescent wrench, according to an embodiment of the present disclosure;

FIG. 30 depicts a diving belt, according to an embodiment of the present disclosure;

FIG. 31 is a flowchart illustrating a method for constructing a floating hand tool, according to an embodiment of the present disclosure; and

FIG. 32 is a flowchart illustrating a method for using a collection of floating hand tools with a diving belt, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

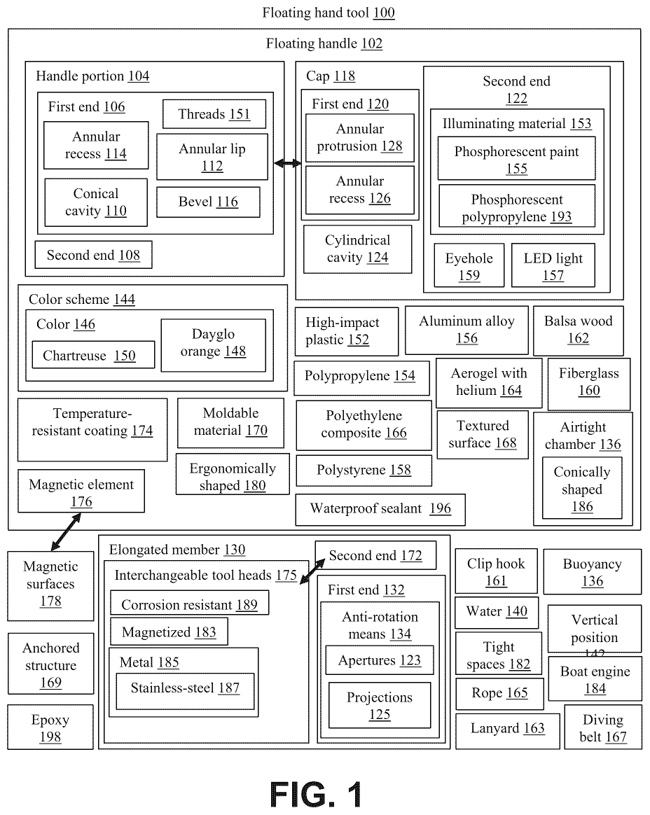

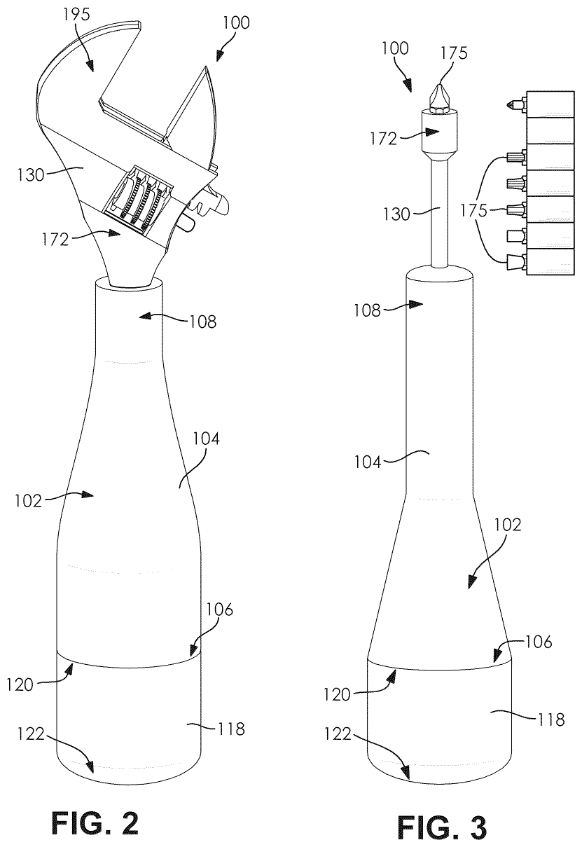

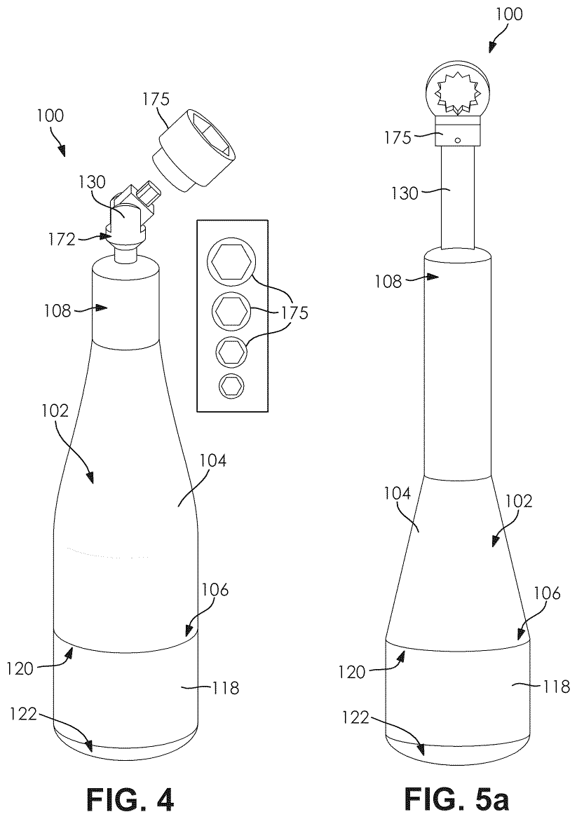

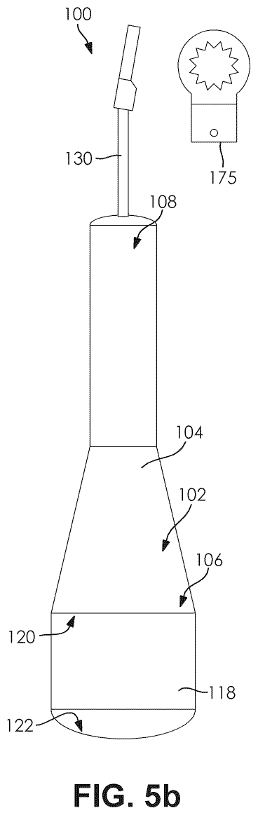

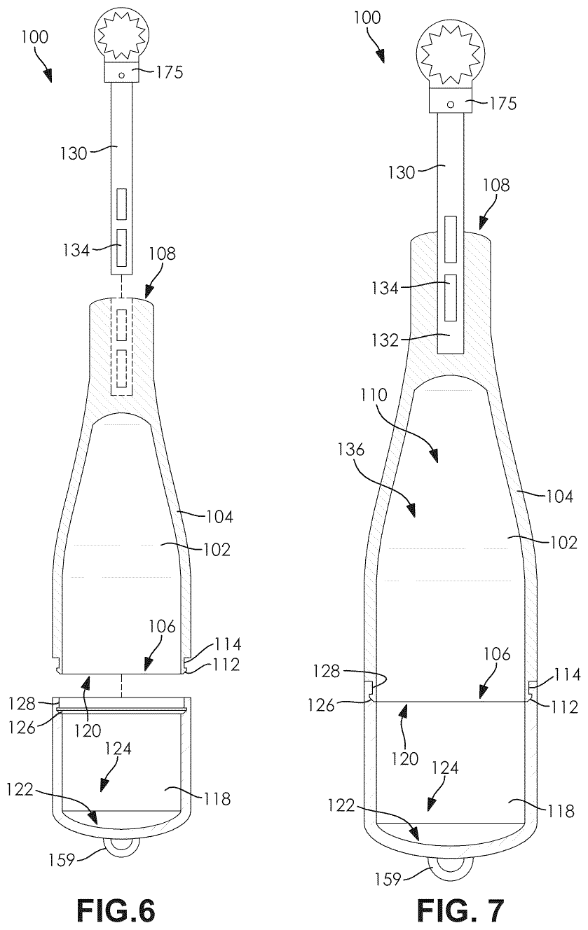

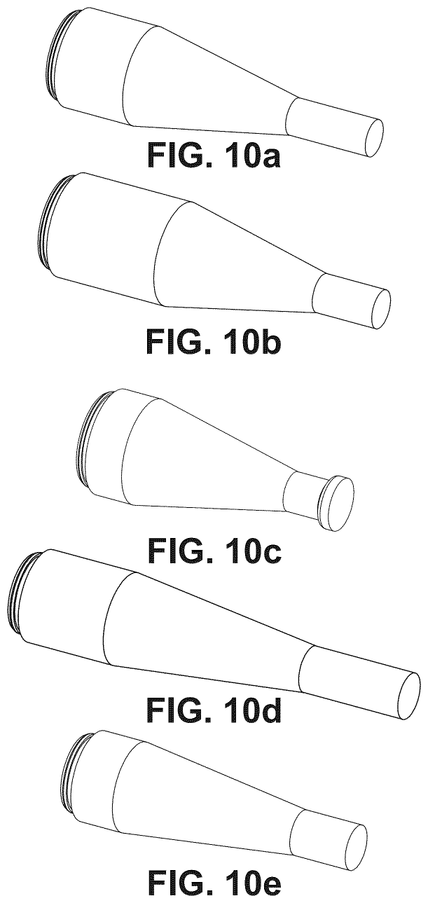

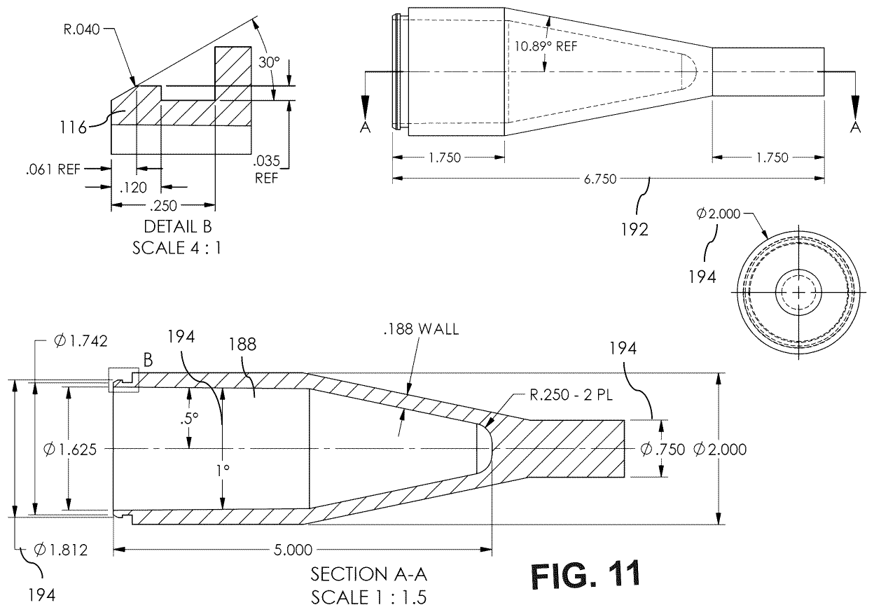

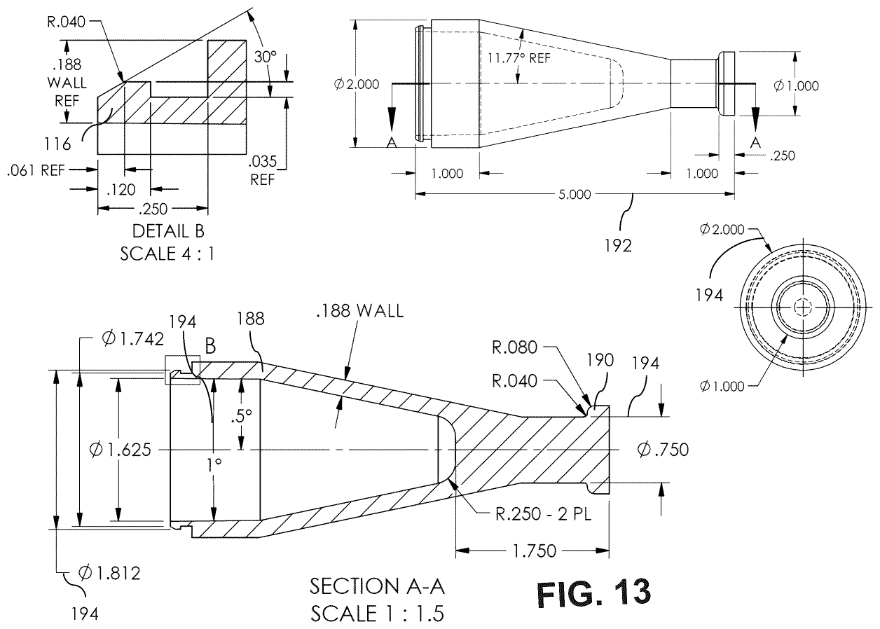

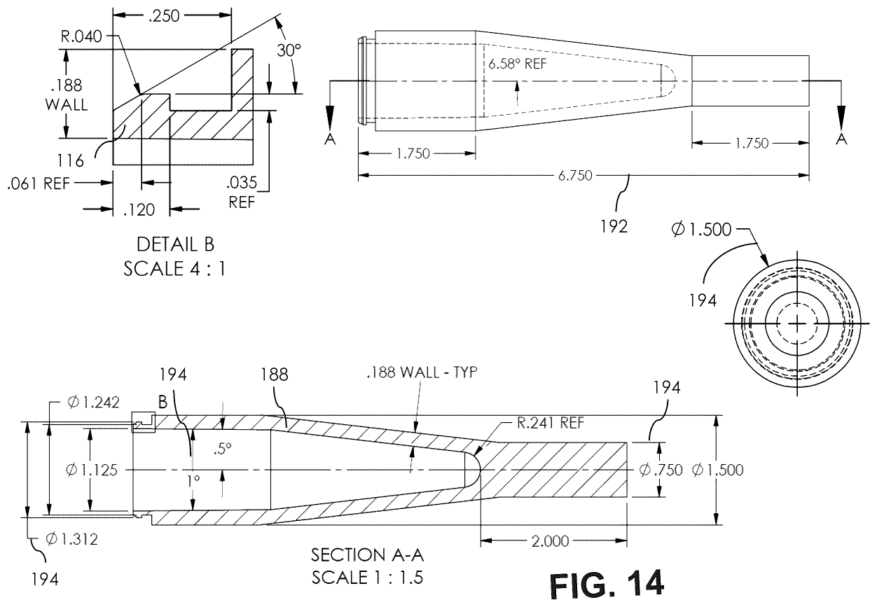

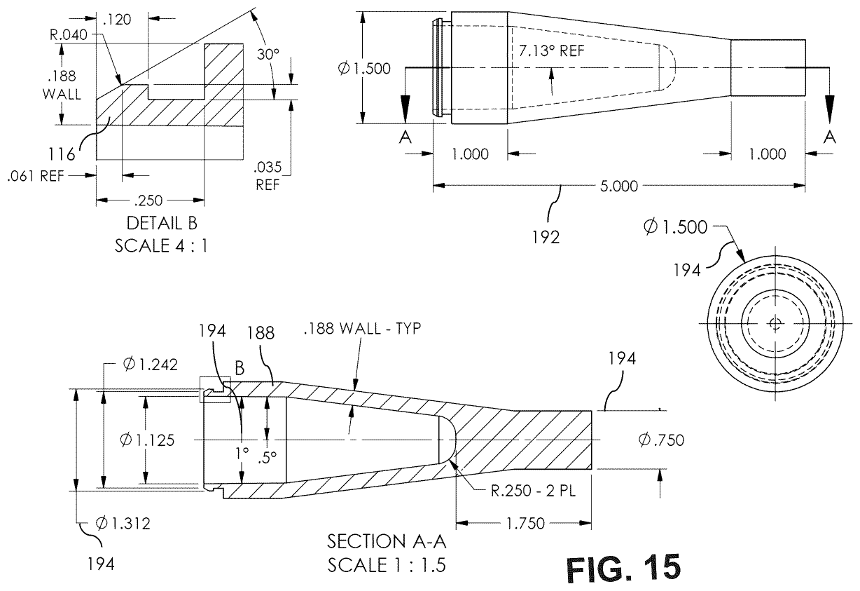

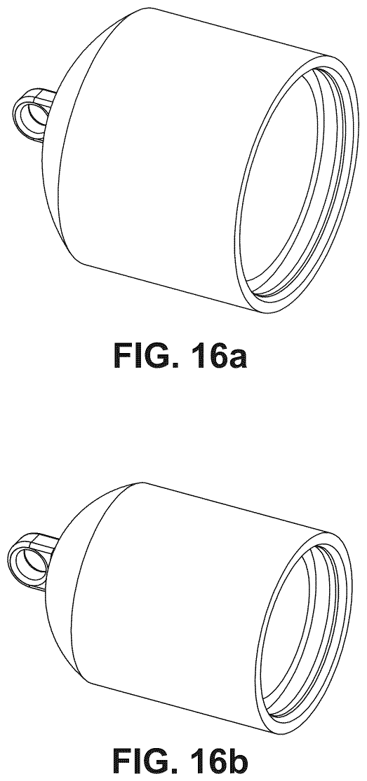

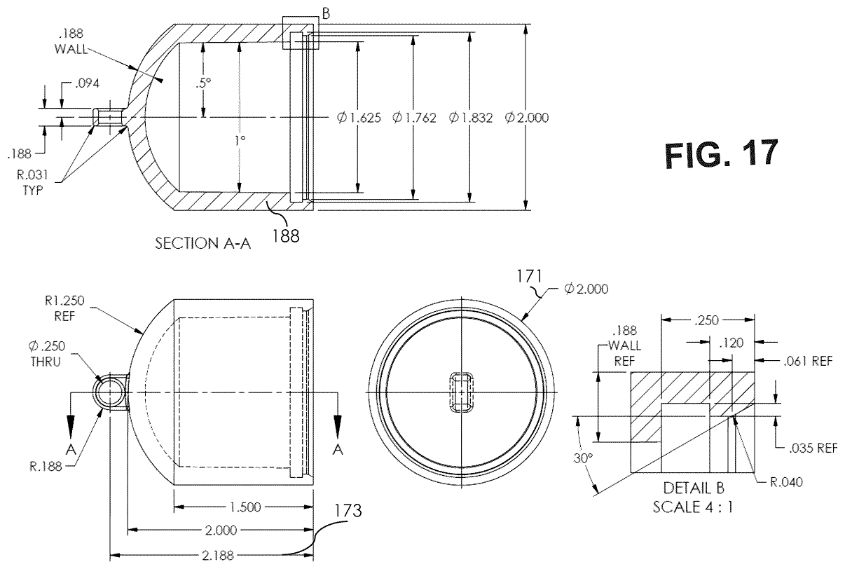

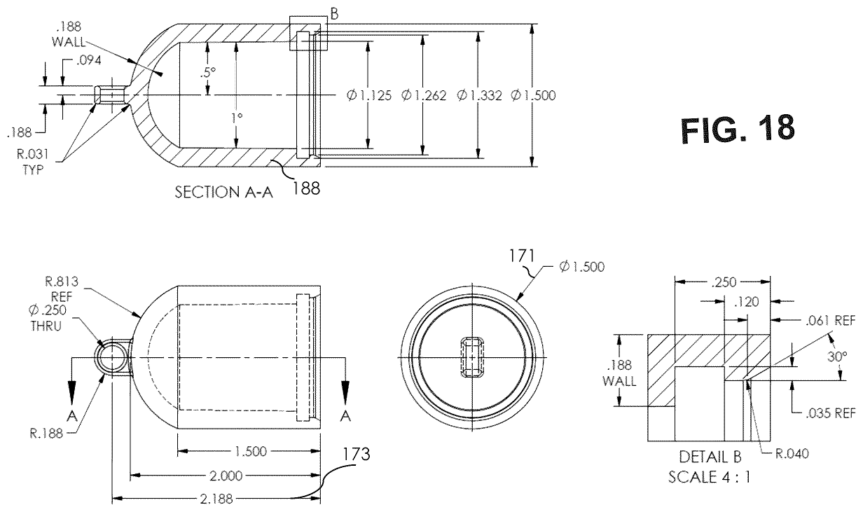

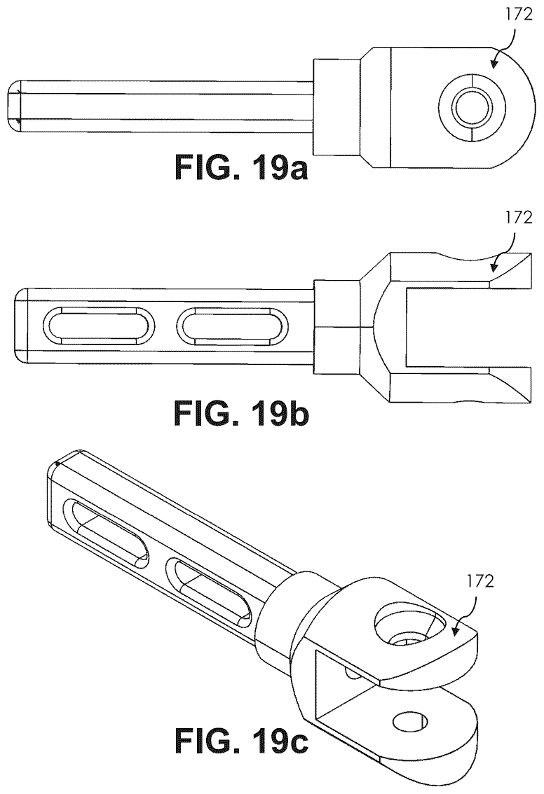

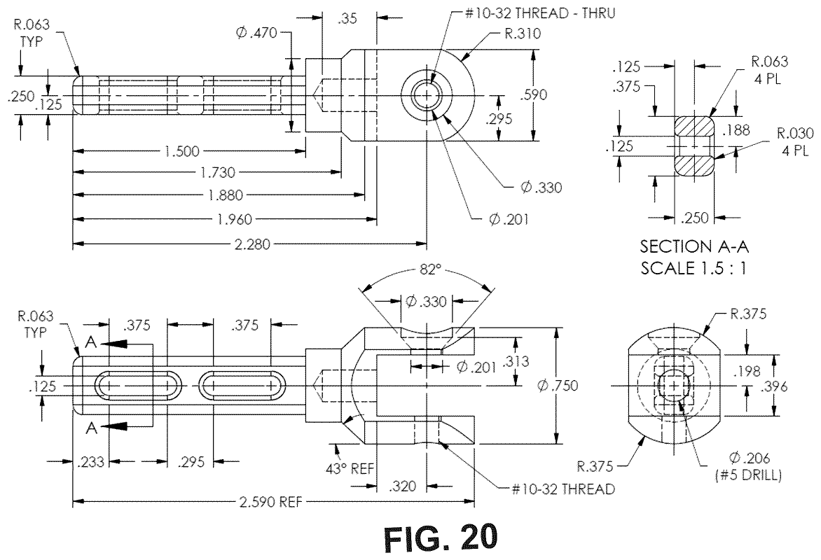

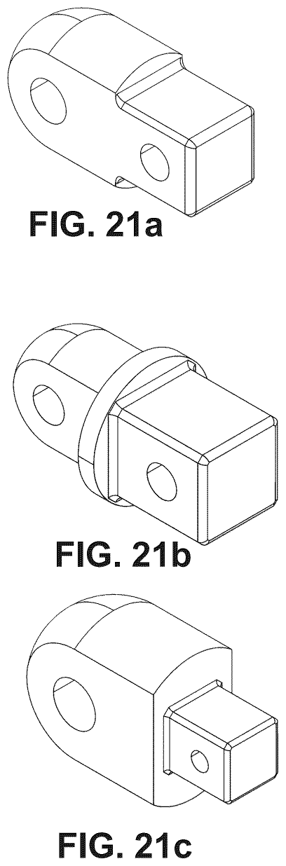

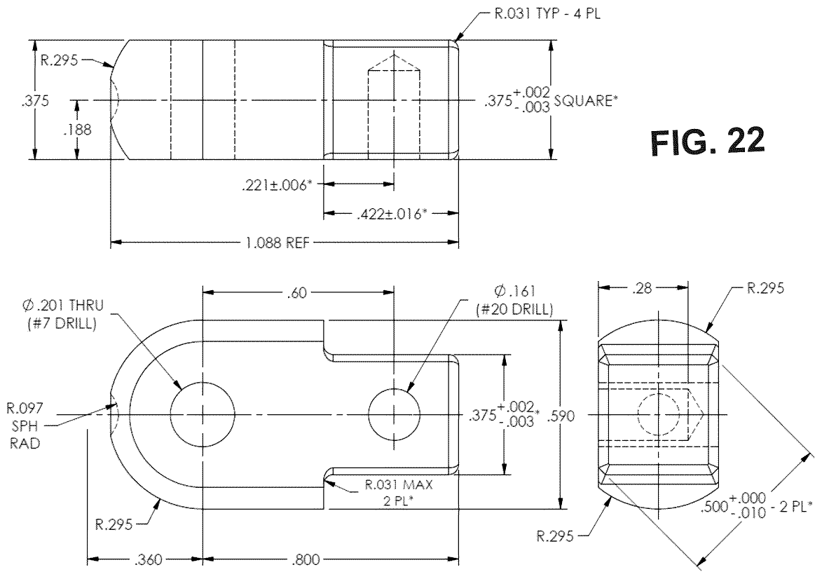

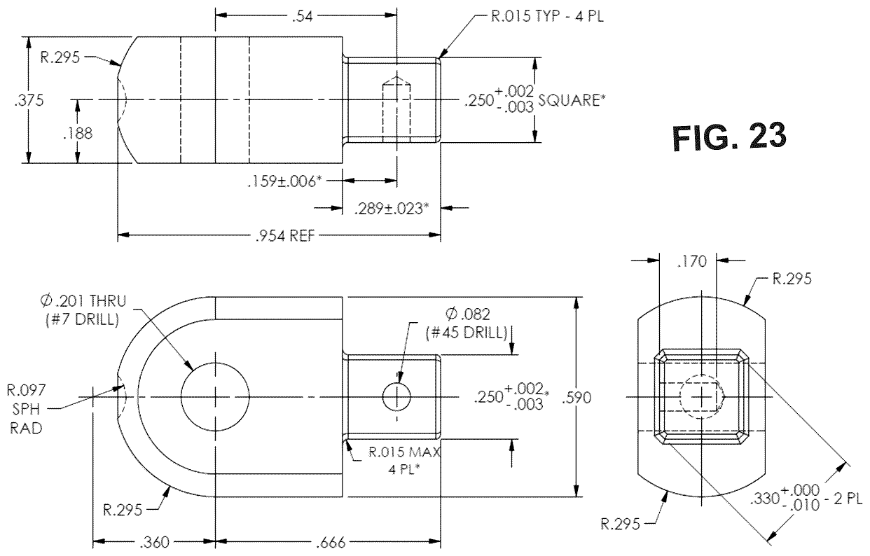

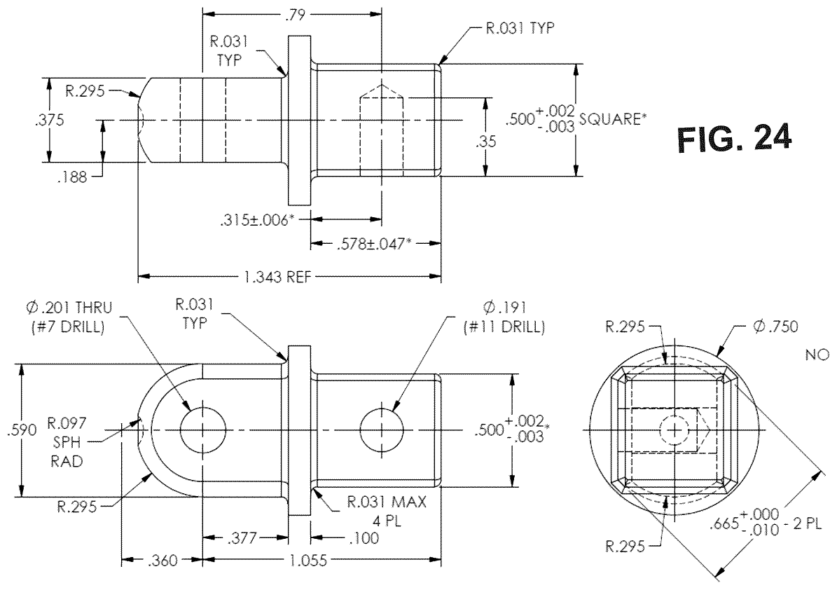

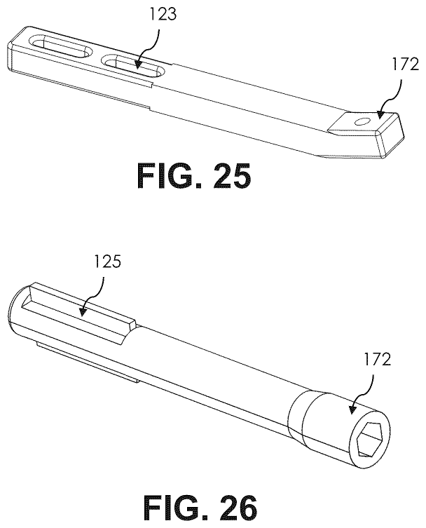

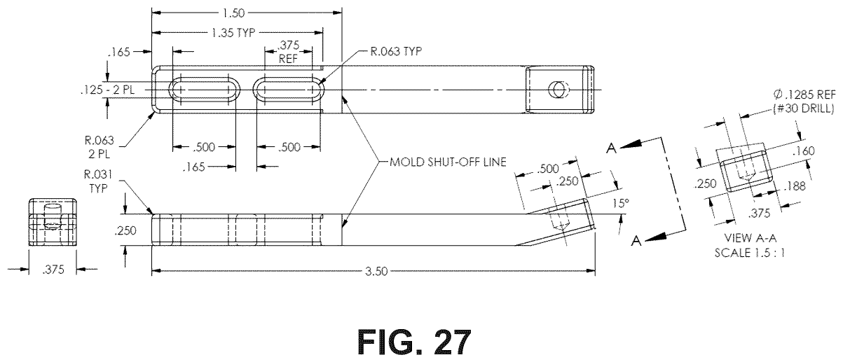

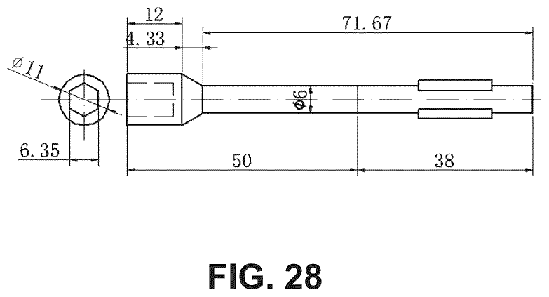

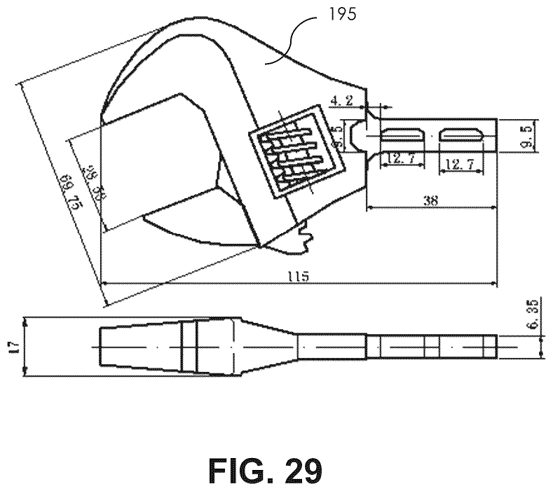

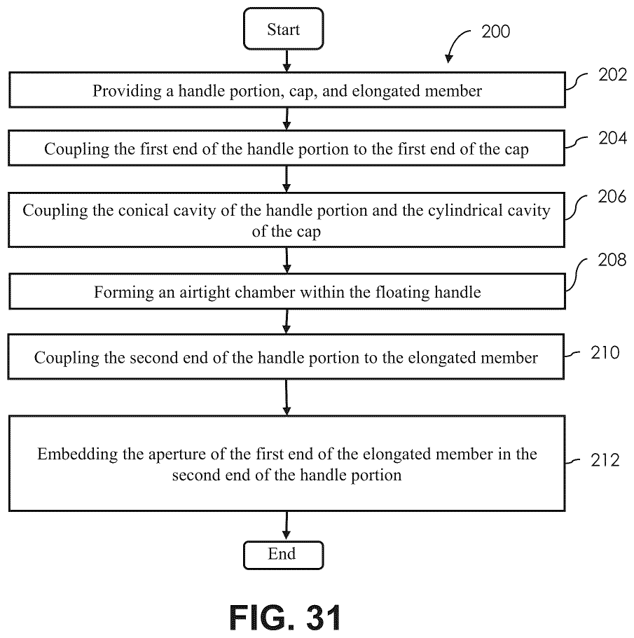

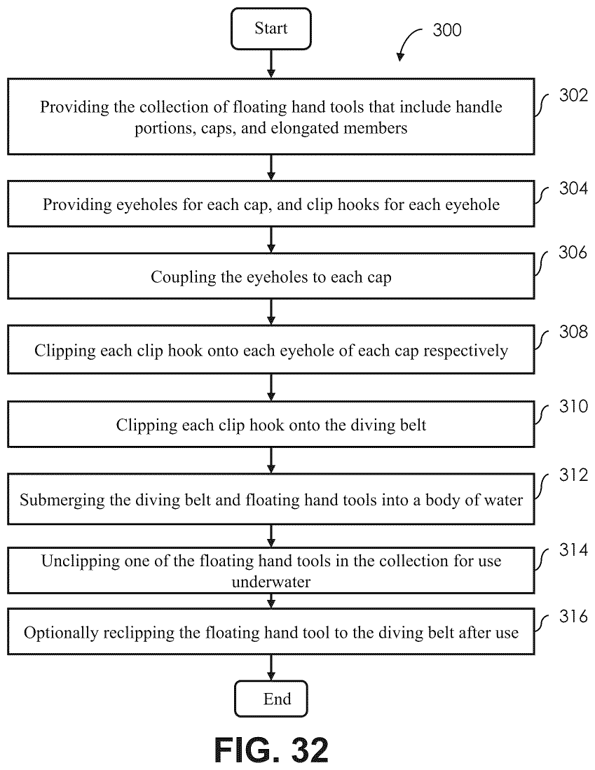

The present technology provides a floating hand tool 100 that can include corrosion resistant interchangeable wrench heads of different sizes and made to float in water 140 where a portion of the handle of the hand tool may be visible above the water 140 line, as shown in FIGS. 1 through 30. A method 200 for constructing a floating hand tool is provided in FIG. 31. Another method 300 for using a collection of floating hand tools 100 with a diving belt 167 is provided in FIG. 32.

As shown in FIGS. 1 through 30, certain aspects of a floating hand tool 100 are illustrated. The floating hand tool 100 may include a floating handle 102. The floating handle 102 may include a handle portion 104 having a first end 106, a second end 108, and a conical cavity 110. The first end 106 of the handle portion 104 may include an annular lip 112 disposed around the first end 106 and an annular recess 114 disposed adjacent to the annular lip 112. The annular lip 112 may also include a bevel 116. The floating handle 102 may also include a cap 118 having a first end 120, a second end 122, and a cylindrical cavity 124. The first end 120 of the cap 118 may include an annular recess 126 and an annular protrusion 128. The annular protrusion 128 may be configured to be selectively coupled to the first end 106 of the handle portion 104 by engaging the bevel 116 of the annular lip 112 of the handle portion 104. The floating hand tool 100 may also include an elongated member 130 having a first end 132, the first end 132 including an anti-rotation means 134. The anti-rotation means 134, for example, may include one or more apertures 123 that fill with material of handle portion 104 when molded therewith. In another example, the anti-rotation means 143 may include one or more projections 125 that prevent rotation when material of the handle portion 104 is molded therewith. The first end 106 of the handle portion 104 may be coupled to the first end 120 of the cap 118. The conical cavity 110 of the handle portion 104 and the cylindrical cavity 124 of the cap 118 may be coupled to form an airtight chamber 136 within the floating handle 102, providing a sufficient volume for an interior space for flotation purposes. The second end 108 of the handle portion 104 may then be coupled to the elongated member 130. Finally, the anti-rotation means 134 of the first end 132 of the elongated member 130 may be embedded in the second end 108 of the handle portion 104. When fully constructed, the buoyancy 138 of the airtight chamber 136 of the floating handle 102 in combination with the weight of the elongated member 130 may allow the floating hand tool 100 to float in a body of water 140 at a vertical position 142 with the cap 118 fully visible above the water 140.

The floating handle 102 may include the following aspects. The floating handle 102 may be manufactured from rigid, durable materials which are relatively low density, such as high-impact plastic 152 or aluminum alloy 154. In a specific example, the floating handle 102 may be constructed with polypropylene 156. Additionally, the floating handle 102 may include polystyrene 158, fiberglass 160, balsa wood 162, aerogel with helium 164, polyethylene composite 166, or any combination thereof. The floating handle 102 may specifically include Pro-fax 6323 general purpose polypropylene 156 homopolymer, which may allow for sufficient buoyancy 138. The advantage of using polypropylene 156 in the floating handle 102 includes the ability to design the floating hand tool 100 to float while still providing a handle portion 104 stable enough to not bend when used in water 140. The floating handle 102 may also include a textured surface 168 to improve grip during wet conditions. The floating handle 102 may also have a portion that includes a moldable material 170 configured to conform to the hand of a user to increase comfort when using the floating hand tool 100 or for secure gripping underwater 140. The floating hand tool 100 may include a temperature-resistant coating 174 on the floating handle 102 to withstand extreme temperatures. The floating hand tool 100 may also include a magnetic element 176 embedded within the floating handle 102 to allow attachment to metal surfaces 178. The floating handle 102 may also be ergonomically shaped 180 to allow for the handle portion 104 to fit easily in the hand of the user and may be capable of fitting in tight spaces 182, such as areas in or near a boat engine 184. Components, component sizes, and materials listed above are preferable, but one skilled in the art will recognize that alternate components and materials could be selected without altering the scope of the present technology.

The color scheme 144 of the floating handle 102 may include the following aspects. As shown in FIG. 1, the cap 118 of the floating handle 102 may be a color 146 visually contrasting from the color 146 of the handle portion 104 of the floating handle 102, creating a bobber-like color scheme 144 to enhance visibility when viewed in murky or deep water 140 or floating above the water 140. Specifically, the color 146 of the cap 118 may be orange 148, and the color 146 of the handle portion 104 may be chartreuse 150. For example, one skilled in the art may use polypropylene 156-based colors 146 including a dayglo orange 148, model no. AC303365 and a chartreuse 150, model no. AC44951, from the company Chroma. It should be appreciated that the contrasting color scheme 144 of the floating handle's 102, specifically orange 148 and chartreuse 150, includes bright complimentary colors opposite of dark blue waves, providing an optimal visual distinction to underwater 140 environments.

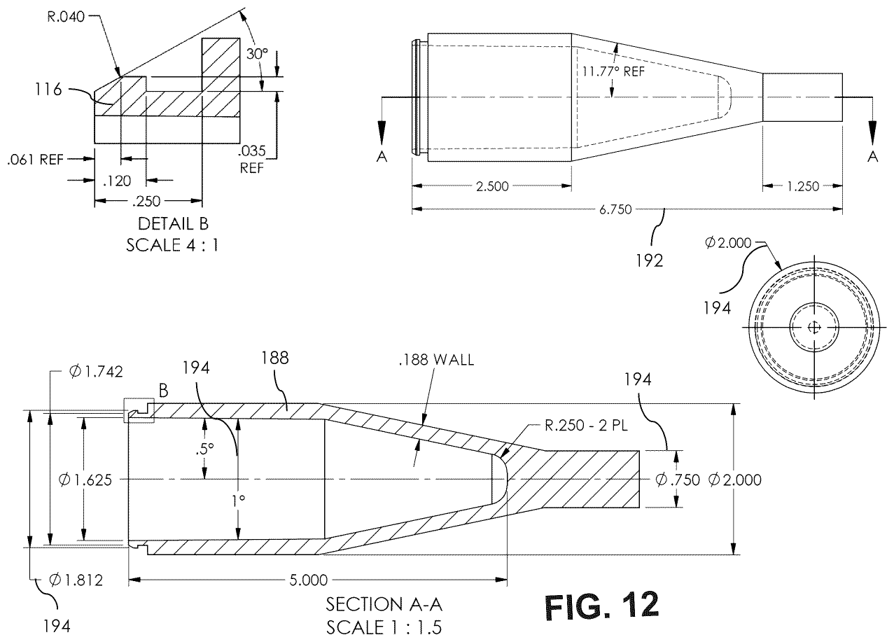

The handle portion 104 of the floating handle 102 may include the following aspects. As shown in FIGS. 10a through 15, when the handle portion 104 is coupled to the cap 118, the airtight chamber 136 may be conically shaped 186. The handle portion 104 of the floating handle 102 may include a sidewall 188 that may be approximately one eighth of an inch thick. The second end 108 of the handle portion 104 may taper slightly. The second end 108 of the handle portion 104 may also include a guard 190 circumscribed around the second end 108 of the handle portion 104. Advantageously, the guard 190 may militate against the user undesirably sliding their hand along the handle portion 104. As shown in FIGS. 12 through 15, the handle portion 104 may have a length 192 of about five inches. Alternatively, the handle portion 104 may have a length 192 of about six and a half inches. The handle portion 104 of the floating handle 102 may be configured for various diameters 194 and lengths 192, depending on the level of buoyancy 138 required for the elongated member 130 and interchangeable tool heads 175 that the floating handle 102 may be coupled with. In one example, the first end 106 of the handle portion 104 may have a diameter 194 of 1.5 inches, and a length 192 of 5 inches, where the first end 106 may have an inner diameter 194 of 1.125 inches, the second end 108 may have a diameter 194 of 0.75 inches, and the conical cavity 110 may have a diameter 194 of 1 inch. In another example, the first end 106 of the handle portion 104 may have a diameter 194 of 2 inches, and a length 192 of 6.75 inches, where the first end 106 may have an inner diameter 194 of 1.812 inches, the second end 108 may have a diameter 194 of 0.75 inches, and the conical cavity 110 may have a diameter 194 of 1 inch. In yet another example, the first end 106 of the handle portion 104 may have a diameter 194 of 2 inches, and a length 192 of 5 inches, where the first end 106 may have an inner diameter 194 of 1.812 inches, the second end 108 may have a diameter 194 of 0.75 inches with a guard 190 coupled to the second end 108 having a diameter 194 of 1 inch, and the conical cavity 110 may have a diameter 194 of 1 inch. In yet another example, the first end 106 of the handle portion 104 may have a diameter 194 of 1.5 inches, and a length 192 of 6 inches, where the first end 106 may have an inner diameter 194 of 1.312 inches, the second end 108 may have a diameter 194 of 0.75 inches, and the conical cavity 110 may have a diameter 194 of 1 inch. In yet another example, the first end 106 of the handle portion 104 may have a diameter 194 of 1.5 inches, and a length 192 of 5 inches, where the first end 106 may have an inner diameter 194 of 1.312 inches, the second end 108 may have a diameter 194 of 0.75 inches, and the conical cavity 110 may have a diameter 194 of 1 inch. To create an airtight chamber 136 within the conical cavity 110 of the handle portion 104 and the cylindrical cavity 124 of the cap 118, the first end 106 of the handle portion 104 may be configured with a waterproof sealant 196 or similar adhesive around the annular recess 114 and the annular lip 112. As an example, the adhesive may be an epoxy 198. The handle portion 104 may be configured to be secured to the cap 118 by the bevel 116 of the annular lip 112 of the handle portion 104. Advantageously, the bevel 116 of the annular lip 112 may enhance the airtight chamber 136 between the cap 118 and the handle portion 104. Alternatively, the handle portion 104 may be configured to include threads 151 that interact with complementary threads 151 on the cap 118, thereby creating an airtight chamber 136 when affixed to the cap 118. One skilled in the art may select other suitable methods for coupling the cap 118 and the handle portion 104, within the scope of the present disclosure.

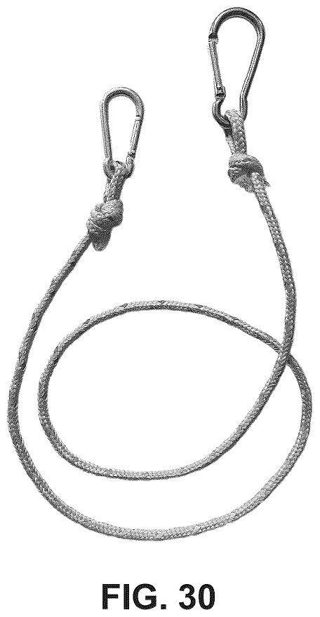

The cap 118 may include the following aspects. As shown in FIGS. 1, and 16a through 18, the cap 118 may include an illuminating material 153. The illuminating material 153 may include phosphorescent polypropylene 193 or may be painted with phosphorescent paint 155. The cap 118 may also include an LED light 157 proximate the first end 120 of the cap 118 for enhanced visibility. The cap 118 may also include an eyehole 159 on the second end 122. The eyehole 159 may be configured to receive a clip hook 161, lanyard 163, or rope 165. The clip hook 161 may be detachably clipped to the eyehole 159 and may be configured to detachably clip the floating hand tool 100 to a diving belt 167 as shown in FIG. 30, or rope 165 for convenient and safe access underwater 140 or near bodies of water 140. Advantageously, the eyehole 159 may also permit a user to couple the floating hand tool 100 to an anchoring structure 169, thereby militating against the floating hand tool 100 from undesirably floating away. The cap 118 may be configured for various diameters 171 and lengths 173, depending on the level of buoyancy 138 required for the elongated member 130 and interchangeable tool heads 175 that the floating handle 102 may be coupled with. In one example, the cap 118 may have a diameter 171 of 1.5 inches, and a length 173 of 1 to 3 inches. In another example, the cap 118 may have a diameter 171 of 2 inches, and a length 173 of 1 to 3 inches. The second end 122 of the cap 118 may be hemispherical or round to comfortably sit in the hands of the user. The cap 118 may also be designed to be capable of fitting into tight spaces 182.

The elongated member 130 may include the following aspects. As shown in FIGS. 19a through 20, and FIGS. 25 through 29, the elongated member 130 includes a second end 172. The second end 172 may be an adjustable crescent wrench 195. The second end 172 may also be configured to have interchangeable tool heads 175, as shown in FIGS. 1, 3 through 9, and 21a through 24. The interchangeable tool heads 175 may include a universal hex wrench 177, a screwdriver 179, or a swivel socket 181. The interchangeable tool heads 175 may come in various sizes. For example, the swivel socket 181 may be configured to receive multiple sizes including ¼, ⅜, and ½ inch heads. The interchangeable tool heads 175 may also be magnetized 183 to decrease the chances of losing the tool heads while working with the floating hand tool 100 underwater 140 or in areas where the floating hand tool 100 may be dropped accidentally into a body of water 140. The elongated member 130 may be coupled to the floating handle 102 via an epoxy 198 resin or similar adhesive. Alternatively, or in addition to an epoxy 198 resin, the handle portion 104 of the floating handle 102 may be formed around the elongated member 130 for enhanced stability. The anti-rotation means 134 of the elongated member 130 may be filled by the handle portion 104. For example, the floating handle 102 may be molded around the elongated member 130, thereby allowing the material used to mold the floating handle 102 to flow through the anti-rotation means 134, embedding the elongated member 130 and anti-rotation means 134 into the handle portion 104. Embedding the material of the floating handle 102 to around the elongated member 130 and through the anti-rotation means 134 allow for enhanced stability and protection of the metal 185 used to make the elongated member 130. The elongated member 130 and interchangeable tool heads 175 may be formed from stainless-steel 187. Advantageously, stainless-steel 187 may be more durable than chromium steel. It should be appreciated that stainless-steel 187 may be especially advantageous in aquatic environments because of stainless-steel's 187 rust-resistant properties. The stainless-steel 187 elongated member 130 and interchangeable tool heads 175 may also be designed to be corrosion resistant 189, benefiting users with professions that work near or in salt water 140.

As shown in FIGS. 7 through 9, the buoyancy 138 of the floating hand tool 100 may include the following aspects. The floating hand tool 100 may have a level of buoyancy 138 where the airtight chamber 136 of the floating handle 102 in combination with the weight of the elongated member 130 allows the floating hand tool 100 to float in water 140 at a vertical position 142 with the cap 118 fully visible above the water 140. The floating hand tool 100 may also be manufactured so that the cap 118 and a portion of the handle portion 104 are fully visible above the water 140. The contrasting colors 146 in combination with the buoyancy 138 of the floating handle 102 may create a buoy effect 191 for high visibility when the floating hand tool 100 is placed or dropped in a body of water 140. The handle portion 104 and cap 118 may include various volumetric capacities of the airtight chamber 136 to provide enhanced floatation to elongated members 130 and interchangeable tool heads 175 of various sizes and weights. Specifically, the handle portion 104 and the cap 118 may be a short or narrower size for an elongated member 130 of a certain weight, while the handle portion 104 and cap 118 may be a longer or wider size for an elongated member 130 with a heavier weight. For example, a longer or wider size handle portion 104 and a larger cap 118 may be coupled to the elongated member 130 when the elongated member 130 is an adjustable crescent wrench 195 or when the interchangeable tool heads 175 is a swivel socket 181. In another example, a shorter or narrower size handle portion 104 and a smaller cap 118 may be coupled to the elongated member 130 when the elongated member 130 is a screwdriver 179. It should be appreciated that the shape of the floating handle 102 with the specific volumetric capacity of the airtight chamber 136 provides a balanced weight distribution while working with the floating hand tool 100 both above and underwater 140. Additionally, the integrated airtight chamber 136 provides the advantages of maintaining a reliable buoyancy 138 over time without absorbing water 140 or corroding due to exposure to salt water 140.

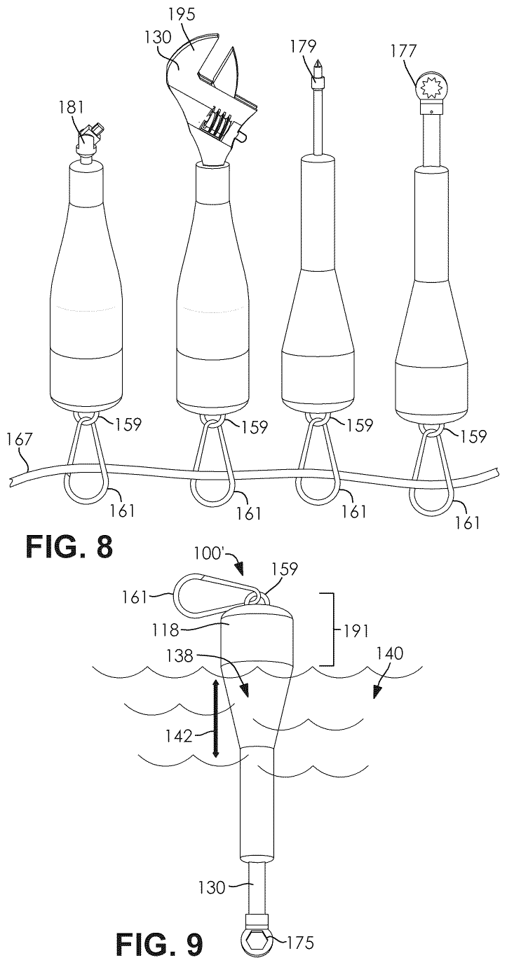

A collection of floating hand tools 100 may also be provided, as shown in FIG. 8. The collection of floating hand tools 100 may be used with a diving belt 167. The collection of floating hand tools 100 may include a plurality of tools each including a floating hand tool 100, each floating hand tool 100 including the handle portion 104, the cap 118, and the elongated member 130. Each cap 118 may also have an eyehole 159. The collection of floating hand tools 100 may also include a plurality of clip hooks 161, each clip hook 161 made to clip onto each eyehole 159 of each cap 118 respectively and made to attach and detach from a diving belt 167.

As shown in FIG. 31, a method 200 for constructing a floating hand tool 100 is provided. The method may include the step 202 of providing a handle portion 104, a cap 118, and an elongated member 130. The method 200 may then include the step 204 of coupling the first end 106 of the handle portion 104 to the first end 120 of the cap 118. The method 200 may include a step 206 of coupling the conical cavity 110 of the handle portion 104 and the cylindrical cavity 124 of the cap 118. The method 200 may include the step 208 of forming an airtight chamber 136 within the floating handle 102. The method 200 may also include the step 210 of coupling the second end 108 of the handle portion 104 to the elongated member 130. Finally, the method 200 may include the step 212 of embedding the anti-rotation means 134 of the first end 132 of the elongated member 130 in the second end 108 of the handle portion 104.

As shown in FIG. 32, a method 300 for using a collection of floating hand tools 100 with a diving belt 167 may include the step 302 of providing the collection of floating hand tools 100 that include a handle portion 104, a cap 118, and an elongated member 130. The method 300 may then include the step 304 of providing eyeholes 159 for each cap 118, and clip hooks 161 for each eyehole 159. The method 300 may then include the step 306 of coupling the eyeholes 159 to each cap 118. The method 300 may then include the step 308 of clipping each clip hook 161 onto each eyehole 159 of each cap 118 respectively. The method 300 may include the step 310 of clipping each clip hook 161 onto the diving belt 167. Next, the method 300 may include the step 312 of submerging the diving belt 167 and floating hand tools 100 into a body of water 140. The method 300 may then include the step 314 of unclipping one of the floating hand tools 100 in the collection for use underwater 140. Finally, the method 300 may optionally include the step 316 of reclipping the floating hand tool 100 to the diving belt 167 after use. Steps 314 and 316 may be repeated as desired.

Advantageously, the floating hand tool's 100 airtight chamber 136 in combination with the weight of the elongated member 130 provides an optimal buoyancy 138 in water 140 for enhanced visibility without the need for external floatation devices. The contrasting colors 146 in combination with the buoyancy 138 of the floating handle 102 may create a buoy effect 191 for high visibility when the floating hand tool 100 is placed or dropped in water 140. Additionally, the floating hand tool 100 may include various sizes without requiring a user to obtain each individual tool based on its individual size and the needs of the user, allowing the user to acquire an abundance of wrenches in a single tool.

### EXAMPLES

Example embodiments of the present technology are provided with reference to the several figures enclosed herewith. These examples highlight how the integrated buoyant handle offers significant practical advantages over other floating tool designs in marine environments.

### Example 1: Diver Performing Underwater Repairs

A diver is conducting maintenance on the underwater hull of a large vessel docked at a marina. During the repair, the diver needs to alternate between a wrench head and screwdriver to tighten and adjust several fittings. Tools without buoyant features would sink if accidentally dropped, creating a time-consuming task of retrieving the tool from the seabed or risking permanent loss in murky waters. While some floating tools are available, they often have bulky attachments that cause drag in the water and make handling more cumbersome.

With the present technology, the diver uses the floating hand tool with the screwdriver elongated member, which includes an integrated handle portion and cap. The floating hand tool is comfortable to handle, and the floating handle provides a textured surface which improves the diver's grip underwater. The integrated floating handle allows the diver to complete tasks efficiently without interference from external floats. If accidentally released, the tool floats gently to the surface, where the diver may easily see the bobber-like color scheme of the floating handle and retrieve it, reducing interruptions to their work and minimizing the risk of tool loss.

### Example 2: Boat Worker Conducting On-Deck Engine Repair

A marine technician on a small fishing boat is repairing the engine while anchored in open seawater. With limited deck space and a need for quick repairs, every tool is kept close at hand. In such a confined and potentially unstable environment, dropping a tool is highly likely, especially when the boat shifts with waves.

Non-buoyant tools would immediately sink, requiring replacement or complex retrieval efforts. The floating hand tool, however, provides an enclosed airtight chamber that offers reliable grip and balanced weight distribution. During the repair, the floating hand tool slips overboard. Once in the water, the floating hand tool floats beside the boat with the floating handle positioned vertically where the cap is fully visible above the water. This position creates a buoy effect, allowing the marine technician to not only quickly find the tool in the water, but also to grasp the floating handle without submerging the technician's hand into the water. The floating handle's dayglo orange and chartreuse contrasting color scheme provides a bobber-like visual effect, allowing the technician to easily find the floating hand tool even if the tool has floated far away from the boat.

After the marine technician retrieves the floating hand tool from the water, the airtight chamber of the floating handle maintains it buoyancy and structural integrity over extended use, even with prolonged use in wet conditions. The marine technician continues to use the floating tool without worrying about corrosion on the interchangeable tool heads due to the floating hand tool's exposure to salt water.

### Example 3: Diver Installing Marine Equipment on an Ocean Floor Structure

A commercial diver is tasked with installing a piece of equipment onto an underwater structure, requiring a collection of the floating hand tools. The diver uses a diving belt, where the collection of floating hand tools is secured to the diving belt with clip hooks. The diver can move freely under water with the floating hand tools clipped to the diving belt, and the tools are out of the diver's way while working on the underwater structure.

Working with floating tools underwater can be cumbersome, disrupting the diver's ability to move freely in the water, or interrupting the diver's workflow when the tools accidentally float beyond the diver's reach. These disadvantages are amplified when using multiple tools on a single piece of equipment. However, the collection of floating hand tools with clip hooks provides the diver flexibility in how the floating hand tools are used and set aside while working. The diver may keep the collection of floating hand tools on the diving belt or attach the collection of floating hand tools to an anchored structure nearby. When a diver intends to work with a specific floating hand tool, the diver can unclip the floating hand tool's clip hook from the diving belt, use the floating hand tool, then reclip the floating hand tool to the diving belt when finish. When working in deep or murky water, the diver can easily see the floating hand tools by their bobber-like color scheme for clipping and unclipping the floating hand tools for use.

When in use, the floating hand tool's integrated buoyant handle design allows the diver to use the floating hand tools that remain balanced and maneuverable, with no external attachments to create drag. The airtight chamber within the handle portion and cap provides buoyancy while preserving a slim profile. If the diver accidentally releases a tool, it will float to the surface rather than sink out of reach to be lost on the ocean floor. This feature greatly reduces the time and effort required to retrieve dropped tools and enhances overall productivity and safety during underwater installations.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with similar results.

What is claimed is:

1. A floating hand tool comprising:
a floating handle including:
a handle portion having a first end, a second end, and a conical cavity, the first end of the handle portion including an annular lip disposed around the first end and an annular recess disposed adjacent to the annular lip, the annular lip including a bevel, and
a cap having a first end, a second end, and a cylindrical cavity, the first end including an annular recess and an annular protrusion, the annular protrusion configured to be selectively coupled to the first end of the handle portion by engaging the bevel of the annular lip of the handle portion;
an elongated member having a first end, the first end including an anti-rotation means;
wherein the first end of the handle portion is coupled to the first end of the cap, the conical cavity of the handle portion and the cylindrical cavity of the cap is coupled to form an airtight chamber within the floating handle, the second end of the handle portion is coupled to the elongated member, and the anti-rotation means of the first end of the elongated member prevents rotation of the elongated member relative to the second end of the handle portion; and
wherein the buoyancy of the airtight chamber of the floating handle in combination with the weight of the elongated member allows the floating hand tool to float in a body of water at a vertical position with the cap fully visible above the water.

2. The floating hand tool of claim 1, wherein the cap of the floating handle is a color visually contrasting from the color of the handle portion of the floating handle.

3. The floating hand tool of claim 2, wherein the color of the cap is orange, and the color of the handle portion is chartreuse.

4. The floating hand tool of claim 1, wherein the buoyancy of the airtight chamber of the floating handle in combination with the weight of the elongated member allows the floating hand tool to float in water at a vertical position with the cap fully visible above the water and a portion of the handle portion fully visible above the water.

5. The floating hand tool of claim 1, wherein a portion of the floating handle includes polypropylene.

6. The floating hand tool of claim 1, wherein the floating handle includes a textured surface to improve grip during wet conditions.

7. The floating hand tool of claim 1, further comprising a temperature-resistant coating on the floating handle.

8. The floating hand tool of claim 1, further comprising a magnetic element embedded within the floating handle.

9. The floating hand tool of claim 1, wherein a sidewall of the handle portion is about one eighth of an inch thick.

10. The floating hand tool of claim 1, wherein a portion of the airtight chamber is conically shaped.

11. The floating hand tool of claim 1, wherein the handle portion has a length of about five inches.

12. The floating hand tool of claim 1, wherein the handle portion has a length of about six and a half inches.

13. The floating hand tool of claim 1, wherein the cap is configured with a waterproof sealant around the recess.

14. The floating hand tool of claim 1, wherein the cap includes an illuminating material, the illuminating material including a member selected from a group consisting of phosphorescent polypropylene, phosphorescent paint, and fluorescent paint.

15. The floating hand tool of claim 1, wherein the cap includes an LED light proximate the first end of the handle portion.

16. The floating hand tool of claim 1, wherein the elongated member includes a second end, the second end configured to be coupled with an interchangeable tool head.

17. The floating hand tool of claim 16, wherein the interchangeable tool head includes a member selected from a group consisting of an adjustable crescent wrench, a universal hex wrench, a screwdriver, and a swivel socket.

18. A method for constructing a floating hand tool, the method comprising the steps of:
providing the handle portion, the cap, and the elongated member of claim 1;
coupling the first end of the handle portion to the first end of the cap;
coupling the conical cavity of the handle portion and the cylindrical cavity of the cap;
forming an airtight chamber within the floating handle;
coupling the second end of the handle portion to the elongated member; and
embedding the anti-rotation means of the first end of the elongated member in the second end of the handle portion.

19. A collection of floating hand tools for use with a diving belt, the collection comprising:
a plurality of tools, each tool including a floating hand tool according to claim 1;
each cap having an eyehole; and
a plurality of clip hooks, each clip hook configured to clip onto each eyehole of each cap respectively and configured to detachably clip onto the diving belt.

20. A method of using a collection of floating hand tools with a diving belt, the method comprising the steps of:
providing the collection of floating hand tools of claim 19;
clipping each clip hook onto each eyehole of each cap respectively;
clipping each clip hook onto the diving belt;
submerging the diving belt and floating hand tools into a body of water;
Unclipping one of the floating hand tools in the collection for use underwater; and
Optionally reclipping the floating hand tool to the diving belt after use.
